(19) United States
(12) Patent Application Publication
(10) Pub. No.: US 2003/0215617 A1
(43) Pub. Date: Nov. 20, 2003

(54) Waterproof and breathable microporous thermoplastic laminated fabric

(76) Inventors: Hussein Shehata, West Windsor, NJ (US); Alan Ziskin, Wayzata, MN (US)

Correspondence Address: Supervisor, Patent Prosecution Services, PIPER RUDNICK LLP, 1200 Nineteenth Street, N.W., Washington, DC, 20036-2412, US

(21) Appl. No.: 10/144,845

(22) Filed: May 15, 2002

(51) Int. Cl. B32B 31/00

(52) U.S. Cl. 428/196; 156/291; 442/290; 156/272.6

(57) ABSTRACT

A laminate comprising a microporous thermoplastic polymer layer such as a microporous polypropylene layer and one or more fabric layers is provided. The laminate is both waterproof and breathable. The laminate is also durable and can be made at low cost. The fabric can be a woven fabric or a knit fabric. Alternatively, a non woven fabric can be used to make a disposable article. The laminate can be used in garments for sports wear, protective clothing or medical uniforms.

### BACKGROUND OF THE INVENTION

1. Field of the Invention

The present invention relates generally to protective garments for wear in rain and other wet conditions which are water resistant (i.e., which keep the wearer dry by preventing the leakage of water into the garment) and moisture vapor permeable to allow perspiration generated inside the garment to evaporate through the garment.

2. Background of the Technology

Microporous film and sheet materials are known. See, for example, U.S. Pat. Nos. 4,539,256; 4,867,881; 4,833,026; 4,613,544; 5,824,405; 6,264,864 and 6,319,864. Moisture vapor permeable and water resistant fabric laminates are also known. These materials typically employ a microporous layer. For example, “GORE-TEX”, which is a registered trademark of W. L. Gore & Associates, Inc., is made from a microporous polytetrafluoroethylene (PTFE) film. The microporous PTFE film is hydrophobic. To make a breathable fabric, the microporous PTFE film is coated with a hydrophilic layer which allows water to diffuse through the film and yet prevents the transport of surface active agents and contaminants, such as those found in perspiration, from contacting the PTFE layer thereby causing it to lose its waterproof characteristics and become a wicking layer. Microporous PTFE, however, is a relatively expensive material and therefore has limited use, especially in the disposable or semi-reusuable garment market and in lower cost re-usable garments.

It would therefore be desirable to provide a product having similar properties of water resistance and moisture vapor transmission to porous PTFE laminates but at a lower cost.

### SUMMARY OF THE INVENTION

According to a first aspect of the invention, a method of making a water resistant and moisture vapor permeable laminate comprising a microporous polymer layer and one or more fabric layers is provided. The method includes: surface treating a first mating surface of the microporous polymer layer to a dyne level of at least about 40; applying a discontinuous coating of an adhesive to the first mating surface of the microporous layer and/or to a mating surface of a first fabric layer; and bonding the mating surfaces of the microporous layer and the first fabric layer together with the adhesive to form the laminate. The microporous polymer layer can comprise polypropylene. The discontinuous coating of adhesive can be applied using a gravure roller, a screen print roller, or using a controlled spray system. The fabric can be a woven, a knit or a non-woven fabric. According to a preferred embodiment of the invention, the microporous polymer layer is surface treated using a corona treatment process. Corona treatment is preferably conducted at a watt density of from about 2.0 to about 8.0 Watts / Ft² / Minute. The adhesive can be a hot melt adhesive, a powder adhesive or a dry web adhesive.

According to a second aspect of the invention, the method set forth above further includes: surface treating a second mating surface of the microporous polymer layer to a dyne level of at least about 40; applying a discontinuous coating of an adhesive to the second mating surface of the microporous layer and/or to a mating surface of a second fabric layer; and bonding the second mating surface of the microporous layer and the mating surface of the second fabric layer together with the adhesive to form a sandwich structure.

According to a third aspect of the invention, a water resistant and moisture vapor permeable laminate is provided. The laminate includes: a microporous polypropylene layer; and a first layer of fabric adhesively bonded to a first mating surface of the microporous polypropylene layer. According to this aspect of the invention, the laminate has a hydrostatic resistance of at least about 35 psi and a moisture vapor transmission rate of at least about 800 grams/sq. meter/24 hours as measured by ASTM E-96 (upright cup). The laminate as set forth above can further include a second layer of fabric adhesively bonded to a second mating surface of the microporous polypropylene layer to form a sandwich structure. The microporous polypropylene layer is preferably substantially free of solid filler material. A garment comprising a laminate as set forth above is also provided. The garment can be a jacket, a poncho, a bib, pants, or a gown.

### BRIEF DESCRIPTION OF THE FIGURES

The invention will be described with reference to the accompanying figures, wherein:

FIG. 1 is a cross-sectional view of a microporous film/fabric laminate according to a first embodiment of the invention; and

FIG. 2 is a cross-sectional view of a fabric/microporous film/fabric sandwich laminate according to a second embodiment of the invention.

### BRIEF DESCRIPTION OF THE INVENTION

The present invention comprises a laminated material of at least two layers of material: a hydrophobic microporous thermoplastic film interior layer and a fabric outer layer. The laminate according to the invention can also comprise a second fabric layer laminated to the hydrophobic microporous thermoplastic film interior layer to form a fabric/microporous layer/fabric sandwich structure. The laminated material according to the invention can be used in any application where the properties of moisture vapor transmission and moisture penetration resistance are desired. The laminate according to the invention can be used, for example, in waterproof garments, protective garments, tents or outdoor sleeping bags, shoes or camping materials.

A suitable hydrophobic microporous thermoplastic film interior layer according to the invention is a polypropylene microporous film as disclosed in U.S. Pat. No. 4,539,256 (hereinafter “the '256 patent”), which is hereby incorporated by reference in its entirety. As set forth in the '256 patent, the polypropylene microprous film can be made from a solution comprising 30-80 parts by weight of crystallizable thermoplastic polymer and 70-20 parts by weight of compound in which the thermoplastic polymer is miscible at the melting temperature of the polymer but phase separates on cooling to at or below the crystallization temperature of the polymer.

A polypropylene microporous film known as “PROPORE”, which is a registered trademark of Minnesota Mining and Manufacturing Corporation, is manufactured using the method described in the '256 patent. The film is waterproof and breathable and has a high resistance to liquid transmission as well as being a barrier to very small particles. Also, the microporous polypropylene film is soft and hypoallergenic.

An exemplary “PROPORE” material has the following specifications:

a thickness of 36 microns;

a Gurley Air Resistance of 80 sec/50 cc;

a pore size of 0.21 microns;

a water hold out of more than 50 lbs./sq. inch; and

a moisture vapor transmission rate (MVTR) of 8,000-10,000 sq. meter/24 hrs.

According to the invention, the microporous polymer film can be surface treated (e.g., corona or plasma treated) on one side or both sides to increase the surface energy and promote bonding to the adjacent fabric layer or layers. According to a preferred embodiment of the invention, the polymer film is surface treated using a corona treatment process. The corona treatment process according to the invention can be conducted using a conventional corona treatment apparatus. According to a preferred embodiment of the invention, corona treatment is conducted a watt density of range 2.00 to 8.00 Watts / Ft² / Minute. “Watt Density” can be calculated from the line speed (FPM), output power, number of sides being treated and electrode width as shown below:

$$\frac{Output power ( in Watts )}{FPM \times Electrode width ( in feet ) \times \# of side} = Watts \text{/} {Ft}^{2} \text{/} Minute$$

According to a preferred embodiment of the invention, corona treatment can be conducted in a continuous process using an output power of 1.5-6.0 KW at a line speed of 150 feet per minute.

Although corona treatment is preferred, other methods of surface treatment can also be used. Non-limiting examples of other surface treatment methods include flame treatment and plasma treatment.

The surface energy of the microporous film is increased by the surface treatment according to the invention. Surface treatment according to the invention is preferably conducted such that the resulting surface of the microporous film has a dyne level of at least about 40, and more preferably from about 40 to about 52. According to a further preferred embodiment of the invention, the treated surface of the microporous film has a dyne level of about 42 to about 46. Higher dyne levels generally result in improved adhesive bonding between the microporous film and fabric layers. However, the more aggressive surface treatments that may be used to obtain higher dyne levels can result in damage to the microporous film layer. For example, high energy corona treatments can result in pin-hole formation in the microporous film layer which can reduce the water resistance of the laminate.

According to one embodiment of the invention, the microporous film can be laminated to a woven or knit fabric to produce a reusuable fabric laminate. Alternatively, the microporous film can be laminated to a non-woven fabric to produce a disposable laminate (e.g., for use in a protective garment). Both reusable and disposable fabrics can be used for outerwear and sportswear, hospital garments (e.g., surgical gowns), clean room garments or in other applications where contact with chemicals (i.e. from chemical spills) is likely to occur.

The fabric laminate of the present invention can be laminated to the microporous film by any conventional lamination method. Exemplary lamination methods are described below. According to a preferred embodiment of the invention, the lamination method employed will provide a laminate having a desired softness, washability, permeability and drape for a particular application.

According to one embodiment of the invention, the fabric can be laminated to the microporous thermoplastic layer using a powder adhesive lamination process, wherein an adhesive in powder form is used. Exemplary powder adhesives which can be used according to the invention include Bostic 5109 or Bostic 5303, which have melting points of 167° F. and 195° F., respectively. Alternatively, the fabric can be laminated to the microporous thermoplastic layer using an adhesive in web form. An exemplary web adhesive is Bostik PE-65, which is a low melting point web adhesive.

According to a further embodiment of the invention, a hot-melt adhesive can be used to laminate the microporous layer to the fabric layer or layers. An exemplary hot melt adhesive is Mor-Melt R 7000™, which is a moisture curing reactive hot melt polyurethane adhesive available from Rohm and Haas. This adhesive is typically used for flexible tiles. The hot-melt adhesive can be applied to the microporous film and/or to the fabric using a hot melt gravure roller, a screen print roller, or a controlled spray system.

Also according to the invention, the microporous film can be laminated to a fabric layer or layers using a liquid adhesive lamination method, in which an adhesive coating is applied with a coating head. The coating head is preferably a gravure roller which has been engraved with a pattern such as a pyramid quad, tri-helical or hexagonal pattern.

A suitable adhesive for liquid adhesive lamination is a polyurethane adhesive. The polyurethane adhesive can be a one or two part urethane adhesive. According to a preferred embodiment of the invention, the adhesive is a solvent based two part system comprising polyurethane and toluene-diisocyanate (TDI). For example, an adhesive formulation comprising polyurethane:TDI with a ratio of 5:1 can be used. Alternatively, a water based polyurethane adhesive and a cross linker for active hydrogen resins can be used. According to a preferred embodiment of the invention, a water based polyurethane adhesive and an aziridine cross-linking agent such as IONAC® PFAZ®-322 (available from Sybron Chemicals, Inc.), which is 90% minimum aziridine, can be used. The use of an aziridine cross-linker can improve the adhesion and the chemical and solvent resistance of the water based polyurethane adhesive.

The amount of adhesive employed should be sufficient to provide an adequate bond while maintaining the moisture vapor transmission properties of the laminate. Increasing the amount of adhesive will generally result in a better bond. However, excessive amounts of adhesive can result in unacceptable moisture vapor transmission properties. The amount of adhesive can be chosen based on the requirements of the application as well as the type of fabric being used. According to the invention, the amount of the adhesive deposited per unit area is preferably from about 1 to about 18 gm/sq. meter. According to a further preferred embodiment of the invention, the amount of adhesive deposited per unit area is about 13 to about 14 gm/sq. meter.

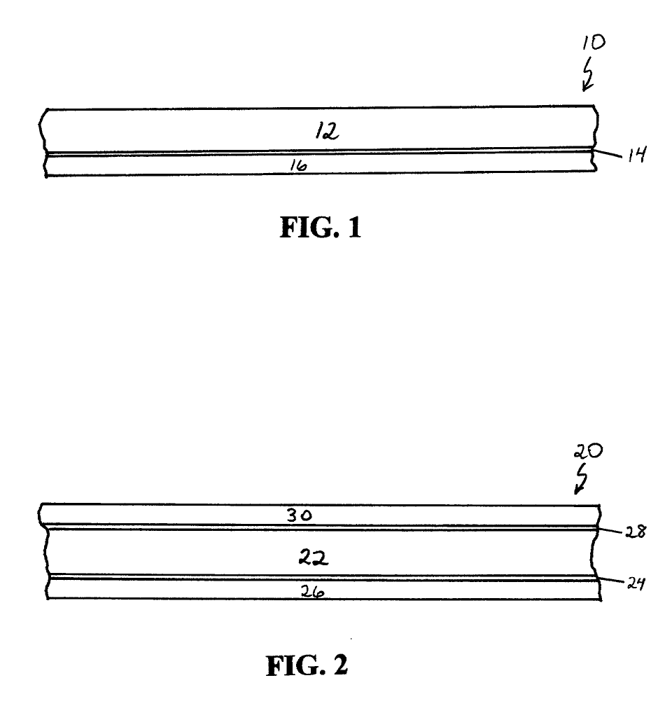

A laminate according to a first embodiment of the invention is shown in FIG. 1. As shown in FIG. 1, the laminate 10 comprises a microporous themoplastic layer 12, a discontinuous adhesive layer 14 and a fabric layer 16. In use, the exposed surface of the fabric layer 16 can be used as the outermost layer of a garment. Moisture vapor (i.e., from perspiration generated inside a garment) can pass through microporous layer 12, discontinuous adhesive layer 14 and fabric layer 16 to the outside of the garment. The fabric layer 16 can provide a water resistant and durable outer layer.

A laminate according to a second embodiment of the invention is shown in FIG. 2. As shown in FIG. 2, the laminate 20 comprises a microporous themoplastic central layer 22, a first discontinuous adhesive layer 24 and a first fabric layer 26. The laminate also comprises a second discontinuous adhesive layer 28 and a second fabric layer 30. The resulting structure is a sandwich structure. In use, the exposed surface of the fabric layer 26 can be used as the outermost layer of a garment. Moisture vapor (i.e., from perspiration generated inside a garment) can pass through inner fabric layer 30, discontinuous adhesive layer 28, microporous layer 22, discontinuous adhesive layer 24 and fabric layer 26 to the outside of the garment. The fabric layer 26 can provide a water resistant and durable outer layer.

The inner fabric layer 30 can be a fabric having a soft touch or feel to improve the comfort of the garment.

According to a preferred embodiment of the invention, the laminate has a hydrostatic resistance of at least about 35 psi and a moisture vapor transmission rate of at least about 800 grams/sq. meter/24 hours, more preferably at least about 1500 grams/sq. meter/24 hours, as measured by ASTM E-96 (upright cup).

The following examples further illustrate the invention.

### EXAMPLE 1

A microporous polypropylene film made according to the method set forth in U.S. Pat. No. 4,539,256 (e.g., “PROPORE” from 3M Corporation) was corona discharge treated to a surface energy of 46 dyne level. The microporous film was then laminated to a fluorescent yellow 100% polyester fabric using a solvent based polyurethane adhesive. The adhesive used was a mixture of a hydroxyl terminated polyester urethane adhesive solution (i.e., Solubond 1117) and an -NCO terminated aromatic polyisocyanate adduct in ethyl acetate (i.e., Solubond 1119). Both Solubond 1117 and Solubond 1119 are available from Soluol Chemicals of R.I.. The adhesive was applied using a gravure roller. The amount of adhesive applied was enough to make a durable, washable product yet not enough to appreciably affect the micro-porosity of the film.

The fabric was then tested for moisture vapor transmission rate. The results are set forth in Table 1 below. For the data shown in Table 1, moisture vapor transmission (in units of grams/sq. meter/24 hours) was measured according to ASTM-E96 at a temperature of 72° F. and at a relative humidity of 50%. Hydrostatic resistance was measured using the A-ASTM D-751, Mullins standard. Colorfastness to laundering was measured using the AATCC-61-Wash Test 2A standard.

TABLE 1

| | |
|---|---|
| Procedure B [Up Right Cup] | |
| First Measurement | 856 |
| Second Measurement | 929 |
| Third Measurement | 866 |
| Average | 884 |
| Procedure BW [Inverted Cup] | |
| First Measurement | 5709 |
| Second Measurement | 4143 |
| Third Measurement | 8455 |
| Average | 6102 |
| Hydrostatic Resistance | |
| First Measurement | 32 |
| Second Measurement | 38 |
| Third Measurement | 45 |
| Fourth Measurement | 32 |
| Fifth Measurement | 28 |
| Average | 35 |
| Colorfastness to Laundering | PASS |

### EXAMPLE 2

The same polypropylene microporous film used in Example 1 was laminated to a fabric using a hot melt 2 part polyurethane adhesive system. The adhesive was applied using a gravure roller. The amount of adhesive used was 10 grams/sq. meter. The microporous polypropylene film was laminated to both a fluorescent yellow 100% polyester fabric and to a blue 100% nylon fabric using the same laminating procedure in each case. The resulting fabric laminates were tested and the results are set forth below in Table 2 below.

TABLE 2

| | YELLOW | BLUE |
|---|---|---|
| | FABRIC | FABRIC |
| Moisture-Vapor Transmission | 1521 | 1565 |
| UPRIGHT ASTM E-96 | 1473 | 1589 |
| | 1612 | 1550 |
| Average | 1535 | 1568 |
| Procedure BW [INVERTED CUP] | 9321 | 7019 |
| | 9893 | 7031 |
| | 10161 | 7941 |
| Average | 9792 | 7330 |
| Hydrostatic Resistance, PSI | 108 | 112 |
| Method A - ASTM D-751 MULLINS | 89 | 112 |
| | 101 | 113 |
| | 86 | 103 |
| | 99 | 106 |
| AVERAGE | 97 | 109 |
| COLOR FASTNESS TO | PASS | PASS |
| LAUNDERING | | |
| AATC-61 WASH TEST 2A | | |

Additionally, a microporous polypropylene film was laminated using the same method as set forth above between two layers of fabric to form a sandwich structure. First, one side of the film was laminated to a fabric using the same hot melt adhesive and the same roller as set forth above. The fabric was left for 24 hours to allow complete curing. A second fabric was then laminated to the other side of the microporous film using the same adhesive and roller. The resulting laminate had a very high moisture vapor transmission rate and a very high hydrostatic resistance.

A variety of different fabrics can be laminated to the microporous polymer layer according to the invention. For example, a fabric made from woven polyester or nylon or any knit fabric or non-woven fabric can be used according to the invention. The fabric can be any fabric suitable for use in water proof breathable garments or tents, or in outerwear, such as sports or protective garments, which permits the transfer of water vapor through the fabric. Additionally, the fabric used as the outer layer of the garment can contain a printed design to achieve a desired aesthetic effect. For example, the outer fabric layer can be a printed camouflage material.

A cotton or polycotton fabric treated with a water repellent coating can also be used as a fabric layer according to the invention. To facilitate adhesive bond formation, the water repellent material can be coated on the major surface of the fabric that does not form a mating surface with the microporous polypropylene layer.

The laminated fabrics according to the invention have both high moisture vapor transmission properties and excellent hydrostatic resistance. Additionally, laminates can be manufactured according to the invention having high durability. Garments made from these laminates can therefore be washed and re-used.

According to a preferred embodiment of the invention, the microporous film and fabric are laminated together using a gravure roller to apply an amount of adhesive sufficient to impart durability and water resistance to the laminate while not significantly reducing the moisture vapor transmission rate (MVTR) of the laminate.

Laminates according to the invention are water and wind resistant and breathable. The laminates can be used in garments (e.g., for outer wear and for protection gowns) as well as for tents or for any other product where breathability as well as wind and water resistance are desired.

According to the invention, the microporous polymer layer can be manufactured from a melt blend of a crystallizable thermoplastic polymer and a compound in which the polymer melt is miscible. As a result, the microporous polymer does not contain a solid filler such as calcium carbonate, which is conventionally used in the manufacture of microporous polymer films. Additionally, the laminates according to the invention are free of PTFE, which is a relatively expensive material. Therefore, according to the invention, laminates having a very high water resistance and very high moisture vapor transmission rate can be made at a relatively low cost. Garments made from laminates according to the invention can therefore be produced more affordably, allowing for the manufacture of both low cost re-usable garments and disposable garments.

These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention.

What is claimed is:

1. A method of making a water resistant and moisture vapor permeable laminate comprising a microporous polymer layer and one or more fabric layers, the method comprising:
surface treating a first mating surface of the microporous polymer layer to a dyne level of at least about 40;
applying a discontinuous coating of an adhesive to the first mating surface of the microporous layer and/or to a mating surface of a first fabric layer; and
bonding the mating surfaces of the microporous layer and the first fabric layer together with the adhesive to form the laminate.

2. The method of claim 1, wherein the first mating surface of the microporous polymer layer is surface treated to a dyne level of about 42 to about 46.

3. The method of claim 1, wherein the discontinuous coating of adhesive is applied using a gravure roller, a screen print roller, or a controlled spray system.

4. The method of claim 1, wherein the fabric is a woven, knit or non-woven fabric.

5. The method of claim 1, further comprising:
surface treating a second mating surface of the microporous polymer layer to a dyne level of at least about 40;
applying a discontinuous coating of an adhesive to the second mating surface of the microporous layer and/or to a mating surface of a second fabric layer; and
bonding the second mating surface of the microporous layer and the mating surface of the second fabric layer together with the adhesive to form a sandwich structure.

6. The method of claim 5, wherein the second mating surface of the microporous polymer layer is surface treated to a dyne level of about 42 to about 46.

7. The method of claim 1, wherein surface treating comprises corona discharge treating or plasma treating.

8. The method of claim 7, wherein surface treating comprises corona discharge treating the microporous polymer layer at a watt density of about 2.0 to about 8.0 Watts/Ft² /Minute.

9. The method of claim 1, where the adhesive is a hot melt adhesive, a powder adhesive or a dry web adhesive.

10. The method of claim 1, where the adhesive is a hot melt adhesive, a solvent based adhesive or a water based adhesive, and wherein the adhesive is applied using a gravure roller.

11. The method of claim 1, wherein the adhesive is a polyurethane adhesive.

12. The method of claim 11, wherein the polyurethane adhesive is a solvent based polyurethane adhesive, a water based polyurethane adhesive or a hot-melt polyurethane adhesive.

13. The method of claim 1, wherein the adhesive is a solvent based polyurethane adhesive comprising toluene diisocyanate (TDI).

14. The method of claim 1, wherein the adhesive is a water based polyurethane adhesive comprising an aziridine cross-linking agent.

15. The method of claim 1, wherein the amount of adhesive applied per unit area is from about 1 to about 18 g/m².

16. The method of claim 1, wherein the amount of adhesive applied per unit area is from about 13 to about 14 g/m².

17. The method of claim 1, wherein the microporous polymer layer comprises polypropylene.

18. A laminate made by the method of claim 1.

19. The laminate of claim 18, wherein the laminate has a hydrostatic resistance of about 35 psi to about 113 psi.

20. The laminate of claim 18, wherein the microporous polymer layer is substantially free of solid filler material.

21. A garment comprising the laminate of claim 18.

22. The garment of claim 18, wherein the garment is selected from the group consisting of a jacket, a poncho, a bib, pants, and a gown.

23. A laminate made by the method of claim 5.

24. A garment comprising the laminate of claim 23.

25. The garment of claim 24, wherein the garment is selected from the group consisting of a jacket, a poncho, a bib, pants, and a gown.

26. A water resistant and moisture vapor permeable laminate comprising:
a microporous polypropylene layer; and
a first layer of fabric adhesively bonded to a first mating surface of the microporous polypropylene layer;
wherein the laminate has a hydrostatic resistance of at least about 35 psi and a moisture vapor transmission rate of at least about 800 grams/sq. meter/24 hours as measured by ASTM E-96 (upright cup).

27. The laminate of claim 26, wherein the laminate has a moisture vapor transmission rate of at least about 1500 grams/sq. meter/24 hours as measured by ASTM E-96 (upright cup).

28. The laminate of claim 26, wherein the microporous polypropylene layer is free of solid filler material.

29. A garment comprising the laminate of claim 26.

30. The garment of claim 26, wherein the garment is an article selected from the group consisting of a jacket, a poncho, a bib, pants, and a gown.

31. The laminate of claim 26, further comprising a second layer of fabric adhesively bonded to a second mating surface of the microporous polypropylene layer to form a sandwich structure.

32. The laminate of claim 31, wherein the microporous polypropylene layer is free of solid filler material.

33. A garment comprising the laminate of claim 31.

34. The garment of claim 33, wherein the garment is an article selected from the group consisting of a jacket, a poncho, a bib, pants, and a gown.

35. A method of making a water resistant and moisture vapor permeable laminate comprising a microporous polypropylene layer and one or more fabric layers, the method comprising:
surface treating a first mating surface of the microporous polypropylene layer;
applying a discontinuous coating of an adhesive to the first mating surface of the microporous layer and/or to a mating surface of a first fabric layer; and
bonding the mating surfaces of the microporous layer and the first fabric layer together with the adhesive to form the laminate.

36. The method of claim 35, further comprising:
surface treating a second mating surface of the microporous polypropylene layer;
applying a discontinuous coating of an adhesive to the second mating surface of the microporous layer and/or to a mating surface of a second fabric layer; and
bonding the second mating surface of the microporous layer and the mating surface of the second fabric layer together with the adhesive to form a sandwich structure.
